(19) United States
(12) Patent Application Publication
(10) Pub. No.: US 2013/0340723 A1
(43) Pub. Date: Dec. 26, 2013

(54) FUEL SYSTEM FOR A VEHICLE

(71) Applicant: Thomas A. Sharp, South Lyon, MI (US)

(72) Inventor: Thomas A. Sharp, South Lyon, MI (US)

(73) Assignee: CHRYSLER GROUP LLC, Auburn Hills, MI (US)

(21) Appl. No.: 13/531,714

(22) Filed: Jun. 25, 2012

(51) Int. Cl. F02M 37/14

(52) U.S. Cl. 123/514

(57) ABSTRACT

A fuel system having a fuel module for use within a fuel tank of a vehicle is disclosed herein. The fuel module includes a fuel reservoir having an inlet for receiving fuel from the fuel tank, a pump for pumping fuel from the reservoir through a fuel supply line and a temperature sensitive valve having a first port for receiving fuel from a return line, a second port for outputting the received fuel into the fuel reservoir, and a third port for outputting the received fuel into the fuel tank and external to the fuel reservoir.

### FIELD

The present disclosure relates generally to vehicle fuel tanks and more particularly to a fuel return thermal bypass system for a fuel module of a vehicle.

### BACKGROUND

In certain vehicle applications fuel routed to an engine may arrive at an undesirable high temperature and may result in the fuel thickening. For example, with certain diesel engines utilized in trucks and passenger cars, fuel may be withdrawn from a fuel module within a fuel tank and then pumped through a supply line to the engine. The fuel needed for combustion is injected into the engine and combusted. Any excess fuel is returned through a return line to the fuel module. As can be appreciated, the unburned fuel will be heated by the engine. Thus, warmer returned fuel begins to collect in the fuel module as the engine operates.

Current vehicle fuel modules dump all of the heated return fuel into the module, which raises the temperature of the fuel being sent to the engine. It is desirable, however, to use fuel cooler than the heated return fuel to achieve better engine performance. Moreover, there is a need to prevent fuel vaporization during warm weather such as e.g., summertime weather.

It is also known that diesel fuel will thicken or “wax” at cold temperatures. In particular, paraffin wax and other materials may crystallize and precipitate from the fuel to form solids. These solids can build up and clog fuel lines, fuel filters and the like. It is therefore, desirable to ensure that waxing does not occur in colder ambient conditions. Accordingly, there is a need for improvement in the art.

### SUMMARY

In one form, the present disclosure provides a fuel module for use within a fuel tank of a vehicle. The fuel module comprises a fuel reservoir having an inlet for receiving fuel from the fuel tank; a pump for pumping fuel from the reservoir through a fuel supply line; and a temperature sensitive valve having a first port for receiving fuel from a return line, a second port for outputting the received fuel into the fuel reservoir, and a third port for outputting the received fuel into the fuel tank and external to the fuel reservoir.

The present disclosure also provides a fuel system for a vehicle. The fuel system comprises a fuel tank and a fuel module within the fuel tank. The fuel module comprises a fuel reservoir having an inlet for receiving fuel from the fuel tank, a pump for pumping fuel from the reservoir through a fuel supply line, and a temperature sensitive valve having a first port for receiving fuel from a return line, a second port for outputting the received fuel into the fuel reservoir, and a third port for outputting the received fuel into the fuel tank and external to the fuel reservoir.

In one embodiment, the temperature sensitive valve comprises a temperature sensitive spring for switching the valve between a first position and a second position. The temperature sensitive spring may be a bimetallic spring.

In one embodiment, the first position occurs when a temperature of the received fuel is less than a predetermined temperature and the second position occurs when the temperature of the received fuel is greater than or equal to the predetermined temperature. The fuel may be diesel fuel and the predetermined temperature may be a waxing temperature of the diesel fuel.

In one embodiment, the received fuel is output from the second port to the fuel reservoir when the valve is in the first position. The received fuel is output from the third port to fuel tank external to the fuel reservoir when the valve is in the second position.

Further areas of applicability of the present disclosure will become apparent from the detailed description, drawings and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIGS. 1 and 2 illustrate a fuel system having a fuel return thermal bypass system in accordance with an embodiment disclosed herein.

### DETAILED DESCRIPTION

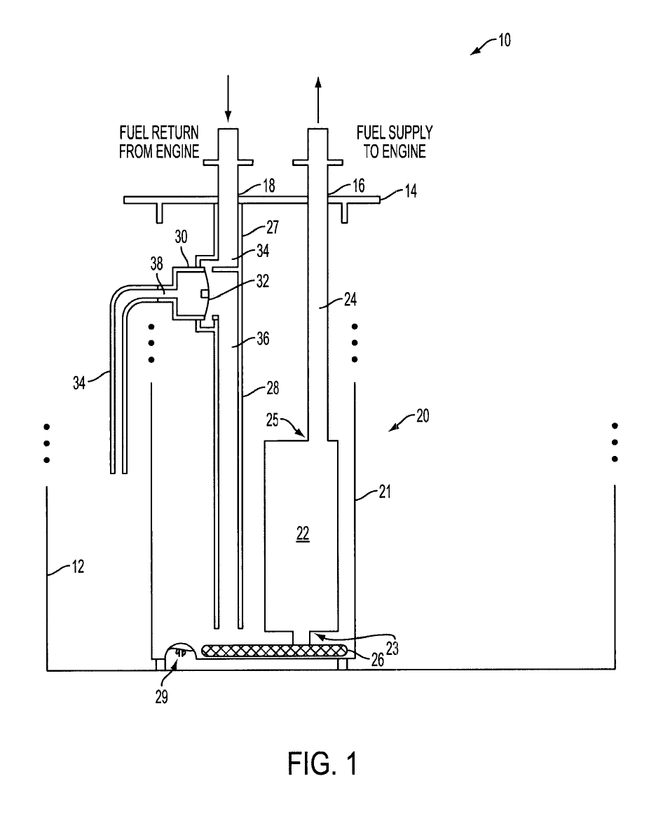

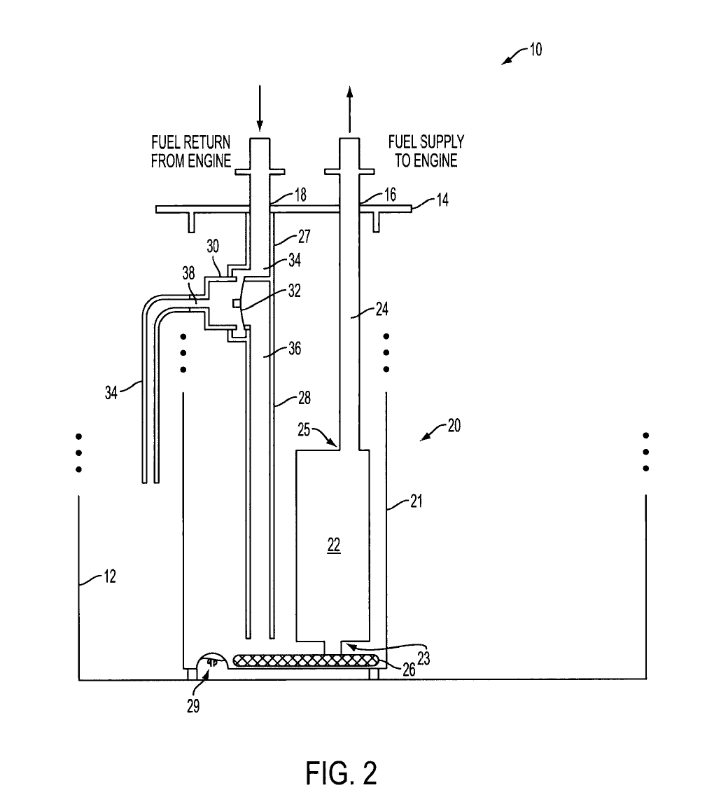

FIGS. 1 and 2 illustrate an example a fuel system 10 constructed in accordance with an embodiment disclosed herein. Embodiments contemplated herein provide for a fuel system that keeps cooler fuel flowing into the engine while also ensuring that there are no waxing problems. The system includes a fuel tank 12 (only a portion of which is shown for clarity purposes) for housing diesel gas or other fuel. Contained within the fuel tank 12 is a fuel module 20. The fuel module 20 has a fuel reservoir 21 having an inlet 29 for allowing fuel from the fuel tank 12 to enter the reservoir 21. A fuel pump 22 is also provided in the reservoir 21 of the fuel module 20. The fuel pump 22 has an inlet 23 coupled to a pump filter 26 and an outlet 25 coupled to a fuel supply line 24. As can be appreciated, the fuel supply line 24 is tubing/piping suitable for allowing fuel to pass there-through. The supply line 24 exits the fuel tank through a first hole 16 in a flange 14, which seals off the module 20.

A first portion 27 of a fuel return line from the engine is provided through a second hole 18 of the flange 14. The first portion 27 of the return line is connected to a first port 34 of a valve 30. A second port 36 of the valve 30 is connected to a second portion 28 of the return line. The second portion 28 of the return line ends within the reservoir 21 of the fuel module 20. As can be appreciated, the first and second portions 27, 28 of the fuel return line are tubing/piping suitable for allowing fuel to pass there-through. A bypass line 34, also a tube or piping suitable for allowing fuel to pass there-through, is connected to a third port 38 of the valve 30 and extends into the fuel tank 12, but external to the fuel module 20.

In a desired embodiment, the valve 30 has a temperature sensitive bimetallic spring 32. The bimetallic spring 32 is configured such that it will have a first position (shown in FIG. 1) when the temperature of the return fuel entering the valve 30 is less than a predetermined temperature. When the spring 32 is in the first position, fuel returning from the engine will travel through the first and second ports 34, 36, through the second portion 28 of the return line, and into the fuel reservoir 21 of the fuel module 20. In the illustrated example, the predefined temperature is approximately the waxing point of typical diesel fuel (e.g., approximately 40 degrees Fahrenheit).

The bimetallic spring 32 is also configured such that it will switch to a second position (shown in FIG. 2) when the temperature of the return fuel entering the valve 30 is greater than or equal to the predetermined temperature. Thus, when the spring 32 switches to the second position, fuel returning from the engine will travel through the first and third ports 34, 38, through the bypass line 34, and directly into the fuel tank 12.

In operation, the pump 22 sucks in fuel from the reservoir 21 (through filter 26) and pumps the fuel through the fuel supply line 24 to the vehicle's engine (not shown). Fuel that is not combusted is returned through the first portion 27 of the return line and enters the valve 30. If the temperature of the returned fuel is less than the predetermined temperature (e.g., approximately 40 degrees Fahrenheit), the bimetallic spring 32 will be in the first position (shown in FIG. 1) causing the returned fuel to travel through the second port 36, the second portion 28 of the return line, and into the fuel reservoir 21 of the fuel module 20. This is desirable because the returned fuel is less than 40 degrees Fahrenheit. As such, cooler fuel will be pumped into the engine.

If, on the other hand, the temperature of the returned fuel is greater than or equal to the predetermined temperature, the bimetallic spring 32 will be in the second position (shown in FIG. 2) causing the warmer returned fuel to travel through the third port 38, the bypass line 34, and into the fuel tank 12. This way, hot fuel is dumped outside of the fuel module 20, keeping the fuel within the reservoir 21 cool (i.e., less than 40 degrees Fahrenheit), but mixing with the fuel in the fuel tank 12 to keep that fuel from waxing.

As can be appreciated, the system 10 disclosed herein allows cooler fuel into the engine during the warmer months (e.g., summertime), which is desirable. The system 10 also provides better engine performance by using cooler fuel. On the other hand, the system 10 is still capable of preventing waxing in colder ambient temperatures because the warmer returned fuel is dispersed throughout the fuel tank 12 and mixed with the other fuel in the tank 12 to prevent waxing when the ambient temperature is at or below the waxing temperature.

What is claimed is:

1. A fuel system for a vehicle, said system comprising:
a fuel tank; and
a fuel module within the fuel tank, said fuel module comprising:
a fuel reservoir having an inlet for receiving fuel from the fuel tank,
a pump for pumping fuel from the reservoir through a fuel supply line, and
a temperature sensitive valve having a first port for receiving fuel from a return line, a second port for outputting the received fuel into the fuel reservoir, and a third port for outputting the received fuel into the fuel tank and external to the fuel reservoir.

2. The system of claim 1, wherein the temperature sensitive valve comprises a temperature sensitive spring for switching the valve between a first position and a second position.

3. The system of claim 2, wherein the temperature sensitive spring is a bimetallic spring.

4. The system of claim 2, wherein the first position occurs when a temperature of the received fuel is less than a predetermined temperature and the second position occurs when the temperature of the received fuel is greater than or equal to the predetermined temperature.

5. The system of claim 4, wherein the fuel is diesel fuel and the predetermined temperature is a waxing temperature of the diesel fuel.

6. The system of claim 4, wherein the predetermined temperature is approximately 40 degrees Fahrenheit.

7. The system of claim 4, wherein the received fuel is output from the second port to the fuel reservoir when the valve is in the first position.

8. The system of claim 4, wherein the received fuel is output from the third port to fuel tank external to the fuel reservoir when the valve is in the second position.

9. The system of claim 1, wherein the second port is connected to a second return line for outputting the received fuel through the second return line and into the fuel reservoir.

10. The system of claim 1, wherein the third port is connected to a bypass return line for outputting the received fuel through the bypass return line and into the fuel tank external to the fuel reservoir.

11. A fuel module for use within a fuel tank of a vehicle, said fuel module comprising:
a fuel reservoir having an inlet for receiving fuel from the fuel tank;
a pump for pumping fuel from the reservoir through a fuel supply line; and
a temperature sensitive valve having a first port for receiving fuel from a return line, a second port for outputting the received fuel into the fuel reservoir, and a third port for outputting the received fuel into the fuel tank and external to the fuel reservoir.

12. The fuel module of claim 11, wherein the temperature sensitive valve comprises a temperature sensitive spring for switching the valve between a first position and a second position.

13. The fuel module of claim 12, wherein the temperature sensitive spring is a bimetallic spring.

14. The fuel module of claim 12, wherein the first position occurs when a temperature of the received fuel is less than a predetermined temperature and the second position occurs when the temperature of the received fuel is greater than or equal to the predetermined temperature.

15. The fuel module of claim 14, wherein the fuel is diesel fuel and the predetermined temperature is a waxing temperature of the diesel fuel.

16. The fuel module of claim 14, wherein the predetermined temperature is approximately 40 degrees Fahrenheit.

17. The fuel module of claim 14, wherein the received fuel is output from the second port to the fuel reservoir when the valve is in the first position.

18. The fuel module of claim 14, wherein the received fuel is output from the third port to fuel tank external to the fuel reservoir when the valve is in the second position.

19. The fuel module of claim 11, wherein the second port is connected to a second return line for outputting the received fuel through the second return line and into the fuel reservoir.

20. The fuel module of claim 11, wherein the third port is connected to a bypass return line for outputting the received fuel through the bypass return line and into the fuel tank external to the fuel reservoir.
